(19) United States
(12) Patent Application Publication
(10) Pub. No.: US 2006/0077269 A1
(43) Pub. Date: Apr. 13, 2006

(54) Pixel binning image sensor

(75) Inventors: Willem J. Kindt, Sunnyvale, CA (US); Brian D. Segerstedt, Redwood City, CA (US)

Correspondence Address: BETH READ;PATENT LEGAL STAFF, EASTMAN KODAK COMPANY, 343 STATE STREET, ROCHESTER, NY, 14650-2201, US

(73) Assignee: National Semiconductor Corporation, Santa Clara, CA (US)

(21) Appl. No.: 10/098,235

(22) Filed: Mar. 15, 2002

(51) Int. Cl. H04N 5/335

(52) U.S. Cl. 348/294

(57) ABSTRACT

An image sensor is disclosed that contains pixel cells that can individually provide a photocharge that is proportional to the magnitude of incident radiation upon each pixel cell. The individual photocharges can be used to construct an electronic image. Additionally, the photocharges of groups of adjacent pixel cells of the image sensor can be combined such that the combined photocharge is proportional to the magnitude of incident radiation upon the group of adjacent pixel cells. The combined photocharge can be read by a converter such as a charge amplifier. The sensitivity of the image sensor is increased at the expense of resolution by iteratively grouping adjacent pixel cells and converting combined photocharges for each group of adjacent pixel cells. Increased sensitivity of the image sensor increases the signal-to-noise ratio of the image sensor in very low light conditions.

### FIELD OF THE INVENTION

The present invention relates generally to imaging systems, and more particularly to an image sensor architecture that bins pixels to enhance the low-light sensitivity of an image sensor.

### BACKGROUND OF THE INVENTION

Image sensors convert an optical image into an electronic signal. An optical image is a visual representation of a scene. A scene contains objects that may be illuminated by light that is visible and/or outside the visible portion of the spectrum (i.e., illuminated by electromagnetic radiation). The light may be from passive (or incidental) light or from active light sources. The light from a scene can be detected by an image sensor and converted into an electronic image by iteratively converting photocharges of arrayed pixel cells into values. The values may be analog or digital. A sequence of the values corresponds to an image signal.

### SUMMARY OF THE INVENTION

The present invention is directed towards an apparatus and method that bins pixels to enhance the low-light sensitivity of an image sensor. More specifically, an image sensor is disclosed that contains pixel cells that can individually provide a photocharge that is proportional to the magnitude of incident radiation upon each pixel cell. The individual photocharges can be used to construct an electronic image. Additionally, the photocharges of groups of adjacent pixel cells of the image sensor can be combined such that the combined photocharge is proportional to the magnitude of incident radiation upon the group of adjacent pixel cells. The combined photocharge is received by a converter such as a charge amplifier. The sensitivity of the image sensor is increased at the expense of resolution by iteratively grouping adjacent pixel cells and converting combined photocharges for each group of adjacent pixel cells. Increased sensitivity of the image sensor increases the signal-to-noise ratio of the image sensor in very low light conditions.

According to one aspect of the invention, an image sensor includes a pixel cells, a column adding switch, and a converter. Pixel cells are arranged in the pixel array. Each pixel cell includes a photodiode that is capable of producing a charge that is directly proportional to the magnitude of incident radiation upon a pixel cell. The produced charge is also directly proportional to the time in which the pixel cell is configured to integrate. The column adding switch is capable of combining a charge produced by each photodiode in the group of binned pixel cells. The converter is capable of receiving the combined charge from each group of binned pixel cells and providing an electronic value in response.

According to another aspect of the invention, a method for pixel binning comprises selecting a plurality of pixel bins in a pixel cell array. A charge for each photodiode is produced within each selected pixel bin that is proportional to the energy of incident radiation received by each photodiode within each selected pixel bin during an interval of time. The charge produced from each photodiode within each selected pixel bin is combined. The combined charge for each pixel bin is converted to a value.

### BRIEF DESCRIPTION OF THE DRAWINGS

FIG. 1 shows an overview schematic of an imaging system in accordance with the present invention.

FIG. 2 shows an overview schematic diagram of an example image sensor used in an imaging system in accordance with the present invention.

FIG. 3 shows a schematic diagram of an example vacuum image intensifying tube in accordance with the present invention.

FIG. 4 is an overview schematic diagram of example one-transistor passive pixel cells within an image sensor according to the present invention.

FIG. 5 is a schematic diagram of an example two-transistor passive pixel cell used in an image sensor according to the present invention.

FIG. 6 is a schematic diagram of a portion of an example pixel binning circuit according to the present invention.

FIG. 7 is a schematic diagram of an example row decoder for pixel binning used in an image sensor according to the present invention.

FIG. 8 is a schematic diagram of an example column adding switch for pixel binning used in image sensor according to the present invention.

### DETAILED DESCRIPTION OF THE PREFERRED EMBODIMENT

In the following detailed description of exemplary embodiments of the invention, reference is made to the accompanied drawings, which form a part hereof, and which is shown by way of illustration, specific exemplary embodiments of which the invention may be practiced. These embodiments are described in sufficient detail to enable those skilled in the art to practice the invention, and it is to be understood that other embodiments may be utilized, and other changes may be made, without departing from the spirit or scope of the present invention. The following detailed description is, therefore, not to be taken in a limiting sense, and the scope of the present invention is defined only by the appended claims.

Throughout the specification and claims, the following terms take the meanings explicitly associated herein, unless the context clearly dictates otherwise. The meaning of “a,” “an,” and “the” includes plural reference, the meaning of “in” includes “in” and “on.” The term “connected” means a direct electrical connection between the items connected, without any intermediate devices. The term “coupled” means either a direct electrical connection between the items connected, or an indirect connection through one or more passive or active intermediary devices. The term “circuit” means either a single component or a multiplicity of components, either active and/or passive, that are coupled together to provide a desired function. The term “signal” means at least one charge, current, voltage, or data signal. Referring to the drawings, like numbers indicate like parts throughout the views.

The present invention is directed towards an apparatus and method for image sensing. An image sensor is disclosed that contains pixel cells that can individually provide a photocharge that is proportional to the magnitude of incident radiation upon each pixel cell. The individual photocharges can be used to construct an electronic image. Additionally, the photocharges of groups of adjacent pixel cells of the image sensor can be combined such that the combined photocharge is proportional to the magnitude of incident radiation upon the group of adjacent pixel cells. A converter such as a charge amplifier can read the combined photocharge. The sensitivity of the image sensor is increased at the expense of resolution by iteratively grouping adjacent pixel cells and converting combined photocharges for each group of adjacent pixel cells. Increased sensitivity of the image sensor increases the signal-to-noise ratio of the image sensor in very low light conditions.

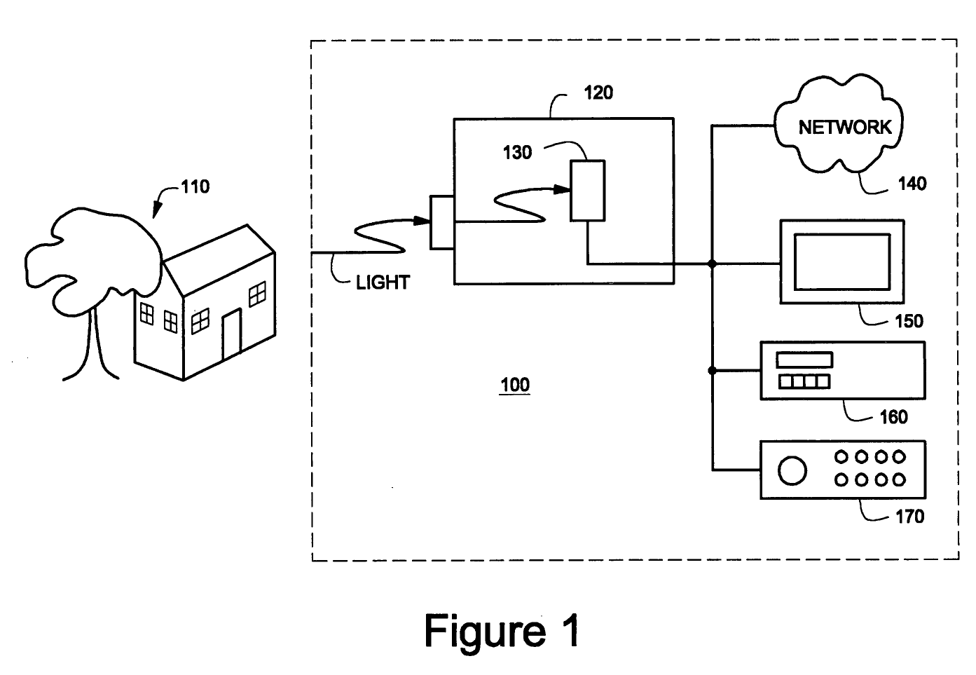

FIG. 1 shows an overview schematic of an imaging system in accordance with the present invention. As shown in the figure, imaging system 100 includes scene 110, camera 120, image sensor 130, network 140, display 150, recorder 160, and processor 170.

Image system 100 receives light from a scene 110 in camera 120. Camera 120 contains image sensor 130. Image sensor 130 converts the received light into an image signal. In various embodiments, the image signal may be conveyed to network 140 for distribution, display 150 for display of an image conveyed by the image signal, recorder 160 for long-term storage, and/or processor 170 for signal processing.

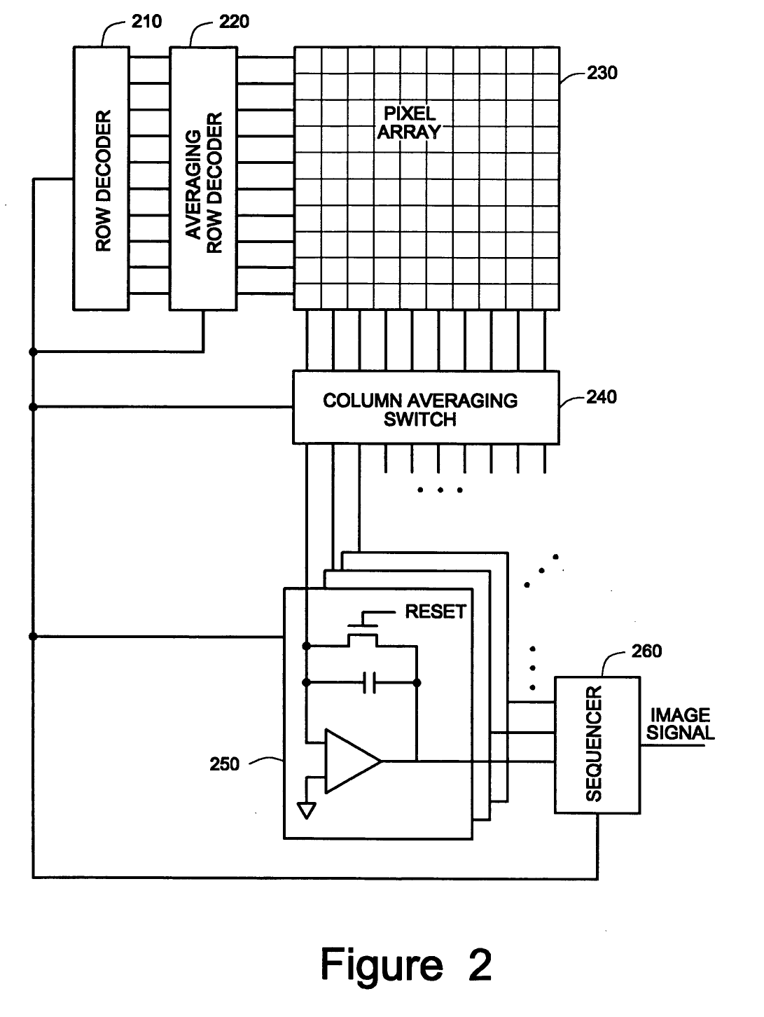

FIG. 2 shows an overview schematic diagram of an example image sensor 200 used in an imaging system in accordance with the present invention. Image sensor 200 includes row decoder 210, averaging row decoder 220, pixel array 230, column adding switch 240, a series of converters 250, and sequencer 260. For clarity, certain repeated instances of exemplary elements (and their associated signals) have been omitted from the figure. For example, pixel array 230 may be instantiated as a 1280 by 1024 pixel cell array whereas pixel array 230 is shown as a 10 by 10 pixel cell array in the figure.

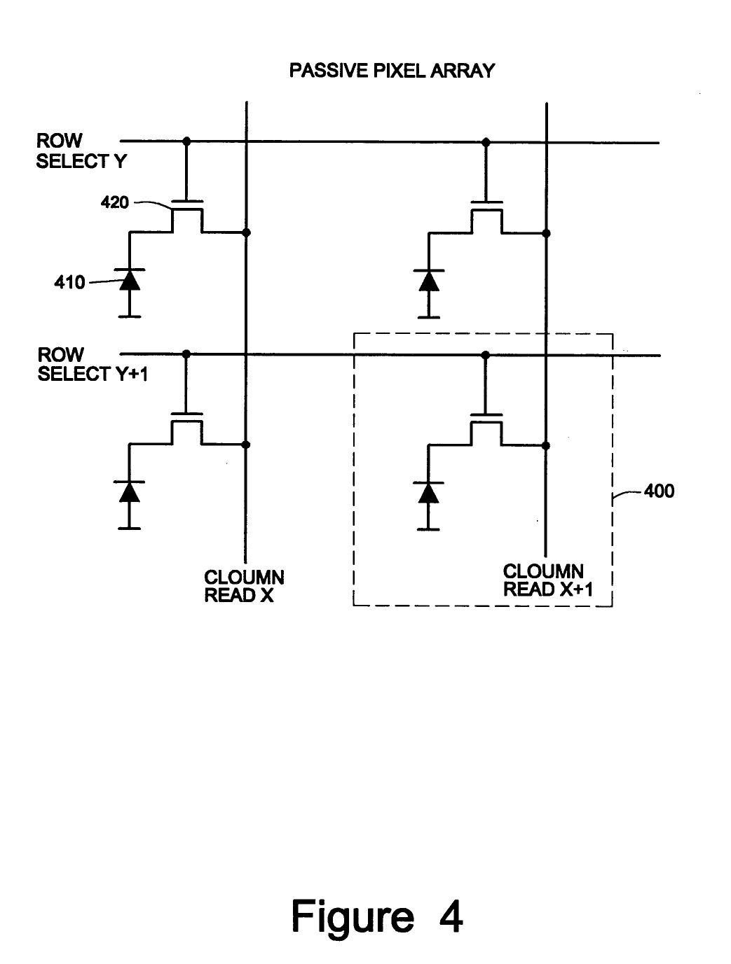

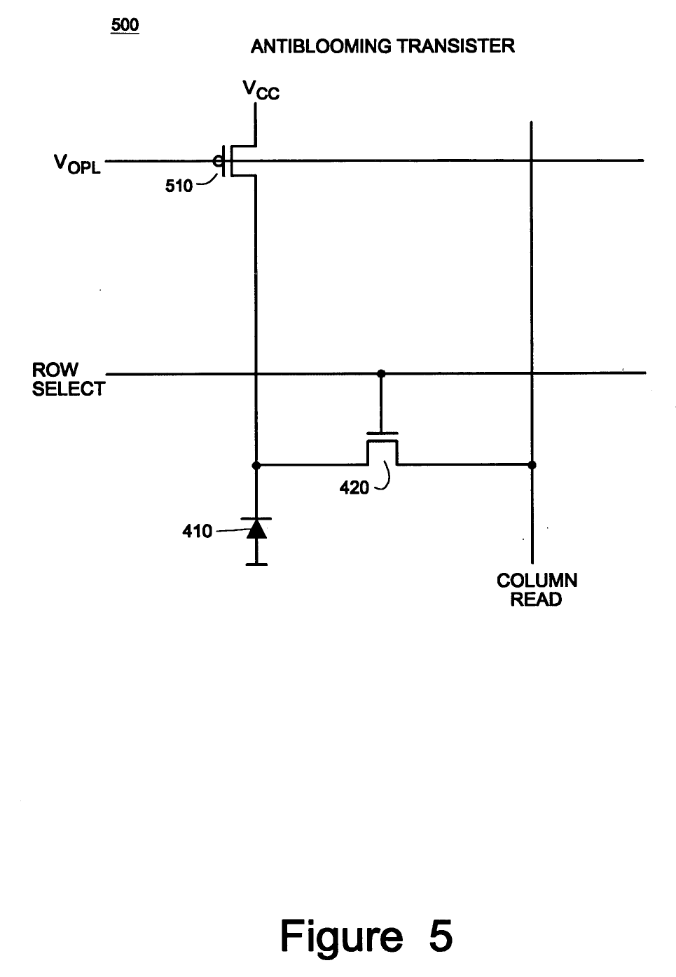

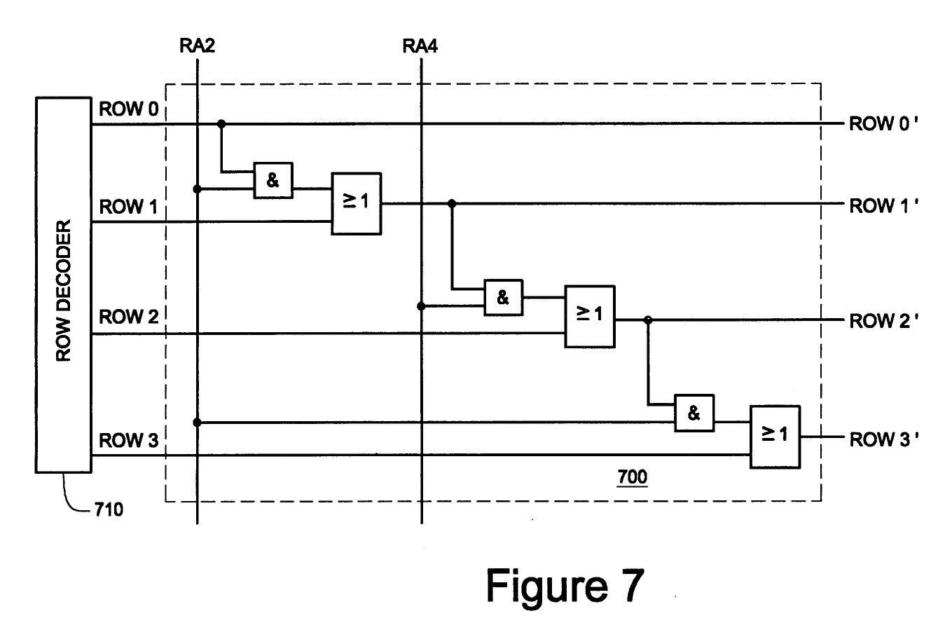

In an embodiment, row decoder 210 receives row addresses from sequencer 260. Row decoder 210 decodes the received row addresses and selects a certain row address line in response. Averaging row decoder 220 receives the type of binning mode, if any, and modifies the selected row address lines in response. Averaging row decoder 220 is described below in further detail with respect to FIG. 7. Row address lines are used to activate pixel cells within a row of pixel array 230. Activating pixel cells allows a charge to be activated within the activated pixel cells. Different types of pixel cells for use in pixel array 230 are described below in further detail with respect to FIGS. 4-5.

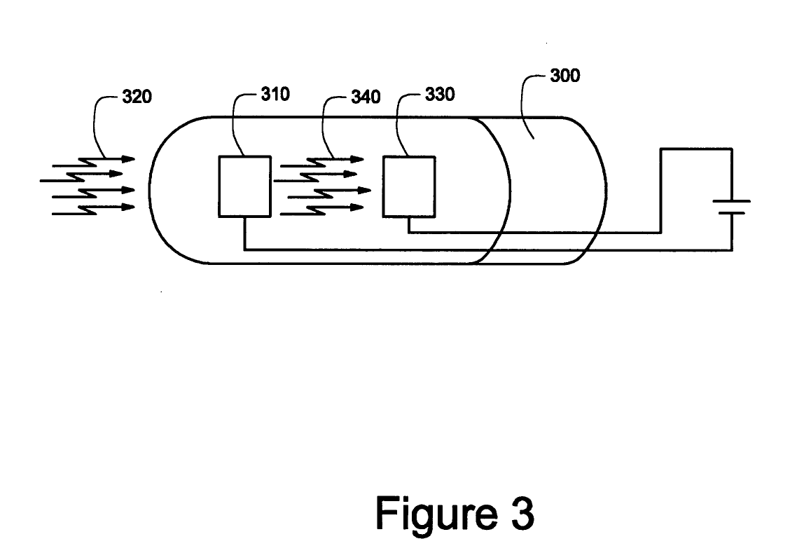

Pixel array 230 includes column read lines from which row selected pixel cells can be read. Column adding switch 240 receives the type of binning mode, if any, and selectively combines various column read lines together in response to the binning mode. The modified column read lines are each associated with one of the series of converters 250. Converter 250 provides a brightness value in response to a photocharge provided by its associated column read line. The photocharge is provided by pixel cell photodiodes within selected rows of pixel array 230. In various embodiments, converter 250 uses a charge amplifier to convert the charge to a voltage (or the electron bombardment to a voltage as described below with respect to FIG. 3). Sequencer 260 controls the timing and operation of each charge amplifier in converter 250 such that the provided brightness values can be used to form an image signal that depicts scene 110.

FIG. 3 shows a schematic diagram of an example vacuum image intensifying tube in accordance with the present invention. In various embodiments, an image sensor may be placed in intensifying tube 300 such that the effect of light upon the image sensor is enhanced. Vacuum image intensifying tube 300 comprises photocathode 310 (upon which light 320 from a scene is directed) and silicon-based image sensor 330. Photocathode 310 and image sensor 330 are typically located in opposing sides of the vacuum image intensifying tube. Photocathode 310 is biased at a large negative potential relative to image sensor 330. Photons impinging upon photocathode 310 create free electrons inside the vacuum tube. The bias voltage across photocathode 310 and image sensor 330 will accelerate free electrons towards the sensor. When the accelerated electrons hit the surface of image sensor 330, a large number of electron hole pairs are created inside the photodiodes of image sensor 330. In contrast, only one electron hole pair is created by a photon that directly impinges upon a silicon-based image sensor. Thus, the use of a vacuum image intensifying tube allows electronic images to be formed in lower light situations.

Image sensor 330 can be made more sensitive to high-energy electrons by performing additional semiconductor processing steps upon image sensor 330. For example, the dielectric oxide on the surface of the sensor may be thinned or removed to expose the silicon surface of the sensor to the electrons. Alternatively, the substrate of image sensor 330 may be thinned to allow electrons to enter the photodiodes of image sensor 330 from the back surface.

FIG. 4 is an overview schematic diagram of example one-transistor passive pixel cells within an image sensor according to the present invention. Each passive pixel cell 400 comprises photodiode 410, selected transistor 420, a row select line, and a column read line. A one-transistor passive pixel cell architecture allows pixel cells to have a higher fill factor for a given pixel size. The fill factor is defined as the ratio of the sensitive pixel area to the total pixel area. The higher fill factor provides a higher signal-to-noise ratio, especially where light levels are relatively low.

Converting received light to a signal is initiated by selecting a row of pixels in a passive pixel array. A row of pixels is selected by pulsing a row select line high. Each photodiode that is in the selected row of pixels can be individually accessed through the column read lines. Through the column read lines, the row-selected photodiodes are charged up to a certain voltage. Subsequently, the row select signal is turned off and the charged photodiodes are arranged to integrate. During integration, the photons incident on the charged photodiodes (or accelerated electrons when being used in an electron bombardment imaging mode) creates a photocurrent in the photodiode that slowly discharges the charged photodiode to a lower potential. After a certain integration time, the slowly discharged photodiodes can be accessed through the column read lines again by enabling the row select line. At this point, the intensity of incident light upon a particular photodiode during the past integration interval can be determined. In various embodiments, a charge amplifier may be used to determine the incident light during the integration interval by measuring the amount of charge that is required to recharge the photodiode to its original bias potential.

In an alternate embodiment, a two-transistor passive pixel cell can be used. FIG. 5 is a schematic diagram of an example two-transistor passive pixel cell used in an image sensor according to the present invention. Two-transistor passive pixel cell 500 operates in similar fashion to one-transistor passive pixel cell 400. Each two-transistor passive pixel cell comprises photodiode 410, select transistor 420, antiblooming transistor 510, a row select line, a column read line, and a voltage overflow line (V_{OFL}). Antiblooming transistor 510 is arranged to prevent an overexposed photodiode from causing blooming during integration. During integration, the potential on an overexposed photodiode drops to around zero volts such that the overexposed photodiode is no longer reversed biased. When the photodiode is no longer reversed biased, the photodiode is no longer capable of storing the charge that is generated by a photocurrent. Any excess electrons that are generated by photons inside the photodiode will be injected into the substrate when the diode potential has dropped to zero volts. The injected electrons can diffuse through the substrate and may be collected by neighboring pixels. Thus, a small bright spot in an image may result in the pixel array producing an electronic image that contains a large overexposed area due to the “blooming” effect.

The gate of antiblooming transistor 510 is biased at a slightly larger potential than its own threshold voltage. Biasing antiblooming transistor 510 to a higher potential allows any excess photocurrent produced by an overexposed photodiode to flow through transistor 510. The current path through antiblooming transistor 510 prevents undesirable electron injection into the substrate such that blooming is minimized in the electronic image produced by the sensor.

The two-transistor passive pixel cell structure (500) can be applied to addressing problems that arise from offset and gain mismatches in the devices that are used to detect pixel charges within a column. In one embodiment, individual charge amplifiers are used to detect pixel charges from selected pixels within a column. Offset and gain mismatches between various individual charge amplifiers results in columnar fixed pattern noise in the electronic image produced by the sensor. Normalizing values produced by each individual charge amplifier reduces columnar fixed pattern noise, which results from offset and gain mismatches between the individual charge amplifiers.

The offset and gain of each individual charge amplifier can be measured by providing rows of “black” pixels and rows of reference pixels within pixel array 500. Black pixel cells can be formed by maintaining an opaque layer over certain pixels of pixel array 500. The opaque layer can be formed by various means including by not etching holes in the oxide above the photodiodes. Reference cells can be formed by using antiblooming transistor 510 to switch a certain reference voltage level to the photodiode of a reference cell. Applying a reference voltage to the photodiode allows the photodiode to be charged to a known voltage prior to measuring the charge of the photodiode. Using antiblooming transistor 510 in reference cells for purposes of calibration (and not for purposes of antiblooming) advantageously allows for layout symmetry of pixel cells within pixel array 500. The reference voltage may be continuously applied to the reference cells (except for the time in which the charge in the cell is read) in order to prevent blooming in the event an opaque layer is not present over the photodiode of the reference cells. The signals generated by the black pixels and the reference level pixels can be used as reference points to calculate offset and gain calibration coefficients such that offset and gain errors (that are introduced by individual column charge amplifiers) may be removed or canceled.

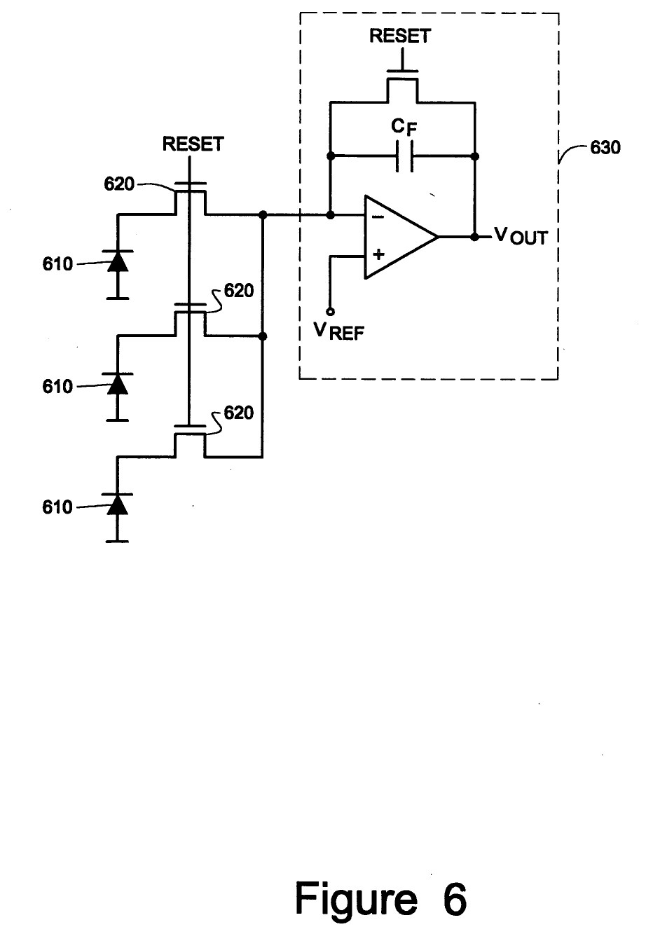

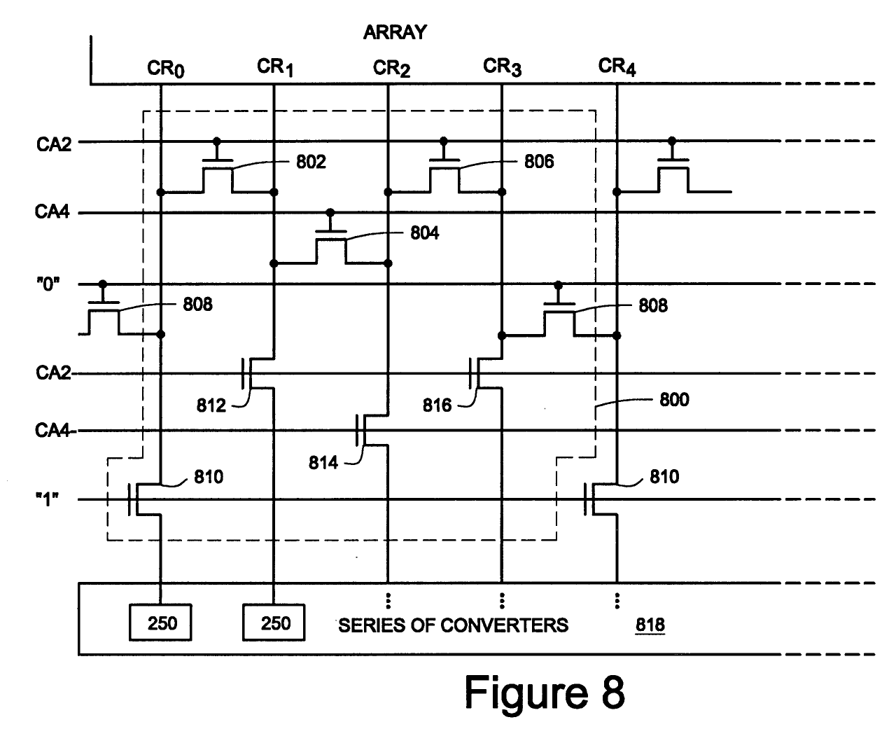

FIG. 6 is a schematic diagram of a portion of an example pixel binning circuit according to the present invention. Each example pixel binning circuit 600 comprises a plurality of photodiodes 610, a plurality of select transistors 620, and a charge column amplifier 630. Photodiodes 610 and select transistors 620 work in similar fashion to the photodiodes and select transistors described above. Certain select transistors 620 are enabled such that the charge produced by the photodiodes coupled to the enabled select transistors is presented to charge column amplifier 630. Charge column amplifier 630 converts the presented charge to a voltage, which is output at signal V_{OUT}. In the embodiments described below with respect to FIGS. 7 and 8, select transistors 620 are implemented as a combination of row select switches and column adding switches.

FIG. 7 is a schematic diagram of an example row decoder for pixel binning used in an image sensor according to the present invention. Pixel binning may be used in low light situations where a noisy image signal may otherwise result. Pixel binning combines output signals of a group of adjacent pixel cells (“pixel bin”) such that a combined output signal can be read as if it were from a single pixel (“combined pixel”). Thus, the combined output signal from the combined pixel (“combined output signal”) has a sensitivity that is greater than the sensitivity of an output signal from a single pixel cell. The sensitivity of the combined output signal is increased by a factor that is equal to the number of pixel cells that are combined to produce the combined output signal.

Pixel bins can be overlapping (where pixel cells may be shared amongst adjacent pixel bins) or nonoverlapping (where pixel cells are not shared amongst pixel bins). In the embodiment described below, the pixel bins are nonoverlapping. Pixel binning may result in decreased resolution of an image signal when nonoverlapping pixel bins are used. For example, a 640 by 480 pixel image sensor may produce a 320 by 240 pixel image signal when a 2×2 nonoverlapping pixel bin is used. The sensitivity of the combined output signal for each pixel in the 320 by 240 pixel image signal is increased by a factor of four.

In different embodiments, row and column pixel binning modes can be accomplished using different integer ratios. For example, a row binning mode of 2:1 can be accomplished by binning two adjacent pixel cells that are in separate rows but are in the same column. Likewise, a row binning mode of 4:1 can be accomplished by binning four contiguous pixel cells that are in separate rows but are in the same column. In a similar fashion, a column binning mode of 2:1 can be accomplished by binning two adjacent pixel cells that are in the same row but are in separate columns. Likewise, a column binning mode of 4:1 can be accomplished by binning four contiguous pixel cells that are in the same row but are in separate columns.

Various row binning modes and column binning modes may be combined. For example, combining a row binning mode of 2:1 and a column binning mode of 4:1 produces a bin of pixel cells four pixel cells wide (i.e., spanning four columns) and two pixel cells high (i.e., spanning two rows). Such a binning arrangement increases the sensitivity of the combined output signal for each pixel bin by a factor of eight.

Combining row and column binning modes that have the same integer ratio results in “square” pixel bins. Using square pixel bins results in the same aspect ratio for the combined output image signal (which uses binning) as the original output image signal (which does not use binning). For example, a 640 by 480 pixel image sensor using a row binning mode of 4:1 with a column binning mode of 4:1 results in a square pixel bin comprised of 16 pixel cells. The resulting combined output image signal is an image of 160 by 120 combined pixels, which maintains the same aspect ratio as the 640 by 480 pixel image sensor.

Averaging row decoder 700 is suitable for implementing the row binning modes of 2:1 and 4:1. Other row binning modes are possible with the use of different logic. Instances of averaging row decoder 700 are replicated every four rows such that each group of four contiguous rows is associated with a single instance of averaging row decoder 700.

One of the groups of four contiguous row select lines is shown in FIG. 7 as being provided by row decoder 710. In normal operation, row decoder 710 selects a single row at a time for reading by a series of column charge amplifiers (i.e., by the series of converters 250). When a row binning mode of 2:1 or 4:1 is used, signals RA2 and RA4 are asserted accordingly. Signal RA2 is asserted in row binning modes of 2:1 and 4:1. Signal RA4 is asserted only in row binning mode of 4:1.

Averaging row decoder 700 asserts output signal Row 0′ whenever input signal Row 0 is asserted (by row decoder 710). Output signal Row 1′ is asserted by averaging row decoder 700 when input signals Row 0 and RA2 are asserted or when input signal Row 1 is asserted. Output signal Row 2′ is asserted when output signal Row 1′ and input signal RA4 are asserted or when input signal Row 2 is asserted. Output signal Row 3′ is asserted when output signal Row 2′ and input signal RA2 are asserted or when input signal Row 3 is asserted.

FIG. 8 is a schematic diagram of an example column adding switch for pixel binning used in image sensor according to the present invention. Column adding switch 800 is suitable for implementing the column binning modes of 2:1 and 4:1. Other column binning modes are possible with the use of different logic. For simplicity, only one instance of column adding switch 800 has been shown. Each group of four column read lines (i.e., CR0-CR3) is associated with a single instance of column adding switch 800. Load switch 810 couples the first column read line (CR0) of a group of four column read lines to an associated converter 250. Converter 250 is one of the converters in series of converters 818.

Input signal “0” is never asserted and is used to “drive” load switch 808. Load switch 808 is a dummy switch that is used to ensure that matching loads are present between all column read lines. Input signal “1” is always asserted and is used to drive load switch 810, which is a dummy switch that is always active. Input signal CA2 is asserted during the 2:1 and 4:1 column binning modes. Input signal CA4 is asserted during the 4:1 column binning mode. Input signals CA2− and CA4− are the inverse of input signals CA2 and CA4, respectively.

When input signals CA2 and CA4 are not asserted (i.e., when pixel binning is not being used), CA2− and CA4− are asserted. Accordingly, switches 810-816 each couple column read lines CR0-CR3 respectively to an associated converter 250.

When input signal CA2 is asserted, adjacent pairs of column read lines are coupled together by switches 802 and 806. Thus, column read lines CR0 and CR1 are coupled together by switch 802 and column read lines CR2 and CR3 are coupled together by switch 806. As a consequence of input signal CA2 being asserted, switches 812 and 816 are turned off. Accordingly, column read line pair CR0 and CR1 is coupled to a single converter 250 through switch 810 (which is always turned on).

Input signal CA4 controls the coupling of column read line pair CR2 and CR3. When input signal CA4 is not asserted, switch 804 is turned off and switch 814 is turned on. Accordingly, column read line pair CR2 and CR3 is coupled to a single converter 250 through switch 816. When input signal CA4 is asserted, switch 804 is turned on and switch 814 is turned off. Accordingly, column read line pair CR2 and CR3 is coupled to column read line pair CR0 and CR1 such that column read lines CR0-CR4 are coupled to the same converter 250. Thus, column read lines from adjacent columns can be combined such that a single column charge amplifier can be used to read the combined column read lines. Furthermore, the column adding switch can be arranged to provide a matching load for each of the column read lines.

The above specification, examples and data provide a complete description of the manufacture and use of the composition of the invention. Since many embodiments of the invention can be made without departing from the spirit and scope of the invention, the invention resides in the claims hereinafter appended.

1. An image sensor for low-light imaging, the image sensor comprising:
a substrate having a thinned width to permit electrons to enter from a back surface, and the substrate includes plurality of pixel cells that are arranged in a pixel array, wherein each pixel cell is arranged to produce a charge that is proportional to the magnitude of an incident radiation;
a column adding switch that is configured to combine the charge from each pixel cell in a group of binned pixel cells, wherein the group of binned pixel cells corresponds to a selected group of the plurality of pixel cells; and
a converter that is configured to receive the combined charge from each group of binned pixel cells and provide a value in response, whereby the sensitivity of the value corresponding to the group of binned pixel cells is greater than the sensitivity of a value corresponding to a charge provided by one of the plurality of the pixel cells.

2-22. (canceled)
